(19) United States
(12) Patent Application Publication
(10) Pub. No.: US 2007/0044576 A1
(43) Pub. Date: Mar. 1, 2007

(54) Torque indicator

(76) Inventors: Leonidas Stephenson, Austin, TX (US); Garris Cox, (US)

Correspondence Address: MATTHEW E. BURR;LAKE AUSTIN MARINA, 2219 WESTLAKE DR, STE 200, AUSTIN, TX, 78746, US

(21) Appl. No.: 11/485,184

(22) Filed: Jul. 12, 2006

Related U.S. Application Data
(60) Provisional application No. 60/698,703, filed on Jul. 13, 2005.

(51) Int. Cl. G01L 7/16

(52) U.S. Cl. 73/862.193; 73/744

(57) ABSTRACT

A gauge calibrated to measure the torque output from a positive displacement hydraulic motor correlates the differential pressure of the motor to the torque of the drive output of the motor and displays the result in units of torque (ft.lbs). Methods for indicating torque and kits for torque gauges are described.

The present disclosure claims priority from U.S. Provisional Application Ser. No. 60/698,703, filed on Jul. 13, 2005, the disclosure of which is incorporated herein by reference.

### FIELD OF THE DISCLOSURE

The present disclosure relates to gauges, and in particular to a gauge that reads torque.

### BACKGROUND

Foundations in compression and tension for various applications in the pipeline or oil and gas industry, electrical utility industry and general construction industry can be can be provided by screw piles having helical blades which are screwed into the ground in a manner that is similar to a wood screw. A positive displacement hydraulic motor whose output shaft is coupled to the top of the pile can be employed to turn the pile and thereby advance the pile into the ground. In a typical pipeline installation, piles are placed on opposite sides of the pipeline and a bracket or saddle is connected to the upper end portions of the piles and to the pipeline to provide a support of foundation therefore. When spaced properly, this provides adequate support, with the piling in either tension or compression.

The level of torque that is required to turn the screw pile into the soil is indicative of the strength of the soil and can be used to predict the capacity of the pile. Low installation torque indicates a weak soil and low pile capacity, whereas high installation torque indicates a strong soil and greater pile capacity. Where the required installation torque can be accurately measured, the approximate holding capacity of a screw pile can be reliably predicted.

Therefore, there is a need for a torgue indicator that displays the degree of torque output by a positive displacement motor. Such a torque indicator may have many advantages, including facilitating better predictions of the holding capacity of a screw pile.

### BRIEF DESCRIPTION OF THE DRAWINGS

A torque indicator of the present disclosure is further described in the detailed description that follows by reference to the noted drawings and by way of non-limiting examples of embodiments of the present disclosure, in which reference numerals represent the same parts throughout the several views of the drawings, and in which:

FIG. 1 is a top view schematic drawing of a specific exemplary embodiment of a torque indicator system of the present disclosure.

FIG. 2 is a top view cross-section schematic drawing showing the internal mechanisms a typical hydraulic differential pressure gauge.

FIG. 3 is a front view schematic drawing of an exemplary specific embodiment of a gauge face of the present disclosure.

FIG. 4 is a front view schematic drawing of an exemplary specific alternative embodiment of a gauge face of the present disclosure.

FIG. 5 is a flow chart of a specific exemplary embodiment of a method of the present disclosure.

### DETAILED DESCRIPTION

Various types of torque indicators have been used in the past. One torque indicator that has been used is a pair of flange or disc members, which provide a coupling mechanism that transmits torque between upper and lower sections of the motor drive shaft. The disc members are formed having axially aligned pairs of holes, each of which is arranged to receive 8 metal pins of a known shear value, for example 500 ft. lbs.

Most indicators of this type will accept from 1 to 20 pins, and possibly more. When the operator desires that the drive shaft be disabled at a torque of about 3,000 ft. lbs., for example, a total of 6 shear pins are mounted in the holes in the disc members. Then the screw pile is torqued down into the ground until the pins shear off, which disables the motor drive shaft at that point. The accuracy of this type of device is difficult to verify and relies on the assumption that the pins are carefully manufactured and have consistent mechanical characteristics.

If the screw pile that is being driven is not fully down to the desired elevation when the pins shear, than a larger number of shear pins must be loaded into the disc members to provide a high torque level at which the drive shaft will be disabled. In any event, a selected number of new pins must be used in order to drive another screw pile during continued installations. Thus, the necessity to repeatedly remove broken shear pins and replace them with new ones results in considerable down time which slows progress of the work, and thus undesirably increases the overall cost of pile foundation construction.

Another type of torque indicator employs the use of a system of hydraulic cylinders and a pressure gauge. This indicator tries to predict the difference between the inlet pressure and outlet pressure. The pressure difference can then be used to predict the torque output of the hydraulic motor. To accomplish this, a rather complicated arrangement of hydraulic cylinders is utilize, with a hose connected to the inlet or pressure side of the hydraulic motor and then plumbed to one of the ports of the cylinder arrangement; and a second hose connected to the outlet or exhaust side of the hydraulic motor and then plumbed to one of the ports of the cylinder arrangement. The pressures applied to the cylinders work against each other in such a way that an estimated pressure difference is indicated on the pressure gauge.

While this hydraulic system has some advantages over the disc type that utilizes shear pins, it presents some problems unique to its hydraulic cylinder design. The hydraulic cylinder is comprised of moving parts. To operate, the cylinder moves in and out in some cases up to 3 inches. As can be imagined, this constant movement creates an environment for wear on the internal piston seals and the interior surfaces of the cylinders.

The piston seals keep the numerous chambers of the cylinder arrangement separated. In some cases, the seals and cylinder walls of the hydraulic cylinders may experience wear, especially if contamination exists within the hydraulic oil system. Cylinder wear results in oil bypassing the pressure seals when pressure is applied, thus relieving some the hydraulic pressure in the various affected chambers of the cylinders to some degree, which could result in the accuracy of the readings coming into question.

Also, in some configurations, two cylinders are connected together and separated by a common seal, which in the example of contaminated oil could damage the seals and cause oil to pass between the two cylinders, thus reducing the accuracy of the readings. If this happens in the field during construction, it is difficult to assess because the affected parts are all internal. This could result in inaccurate readings, which could compromise screw piling system design.

It is the nature of hydraulic cylinder bores, seals and pistons to wear over time. All of these conditions result in the necessity of additional maintenance and re-testing of the hydraulic components, which is time consuming and costly.

The accuracy of the readings of the hydraulic cylinder system is also affected to some degree by the inherent problem of hysteresis in hydraulic cylinders. Hysteresis is a retardation of the effect when forces acting on a body are changed through internal friction or viscosity. Hydraulic systems use numerous piston seals and rod seals and are therefore subject to the effects of hysteresis due to friction.

The viscosity of the hydraulic oil inside the cylinder chambers is subject to change due to variations in temperature be they changes in ambient or operating temperature. Because of the changes in viscosity, the hydraulic system is subject to hysteresis due to viscosity changes. Hysteresis may not be objectionable in a more typical application of a hydraulic cylinder, such as for raising the boom or bucket on construction equipment. However, when the cylinder is used as a precision measuring instrument to precisely predict slight pressure differences in a hydraulic system, then the hysteresis may be significant enough to raise questions regarding the accuracy of the system.

Accordingly, the present disclosure describes a torque indicator that accurately displays screw pile installation torque, for example, while eliminating the disadvantages identified above.

In view of the foregoing, this description, through one or more various aspects, embodiments and/or specific features or subcomponents, is thus intended to bring out one or more of the advantages that will be evident from the description. The present description may make reference to torque measurements for earth screw anchors. It is understood, however, that earth anchor applications are merely an example of a specific embodiment of the present disclosure, which is directed broadly to torque gauge indicators within the scope of the disclosure. The terminology, examples, drawings and embodiments, therefore, are not intended to limit the scope of the disclosure.

Anchor installation torque is directly related to anchor holding capacity. Knowing the installation torque of a screw anchor means one can accurately calculate the ultimate holding capacity of an installed anchor. For numerous construction applications, once the output torque of a hydraulic motor is known then the force applied is known.

A positive displacement motor measures the pressure drop across a hydraulic motor by simultaneously measuring pressure on the pressure side and return side of a hydraulic motor during operation. It is well known that the output torque of a positive displacement motor is proportional to the pressure drop. Accurately measuring this pressure drop (sometimes referred to as “differential pressure”) means one can calculate the amount of torque that is developed by a hydraulic motor. Accordingly, a gauge of the present disclosure provides a new unit of measurement for positive displacement motors, which is torque as displayed in ft.lbs., previously unavailable to those for whom a knowledge of torque output by a positive displacement motor that exhibits differential pressure is desired.

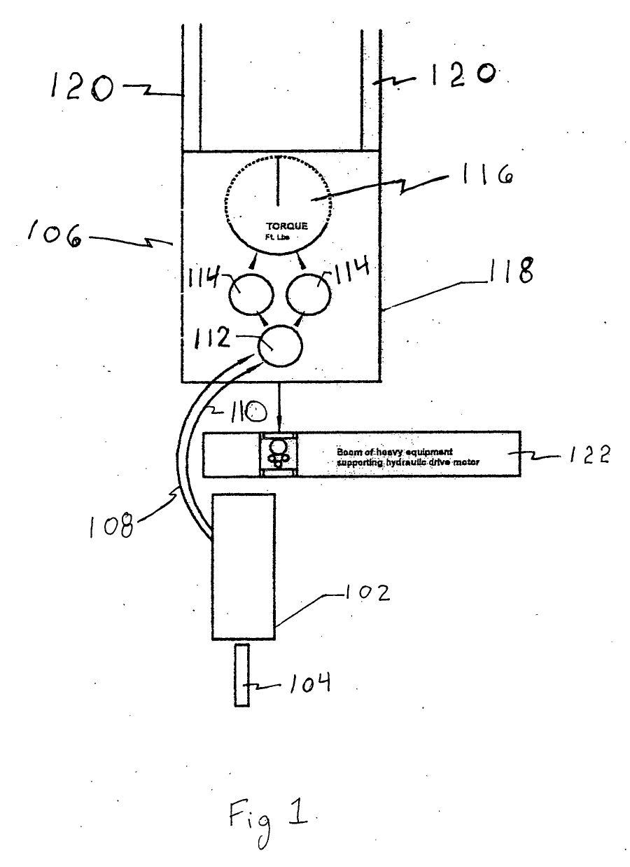

Turning now to the drawings, FIG. 1 is a top view schematic drawing of a specific exemplary embodiment of a torque indicator system of the present disclosure. Hydraulic drive positive displacement motor 102 may deliver torsional force to an anchor or pile screw from output shaft 104. Motor 102 is also connected to hydraulic pressure differential gauge 106 by hydraulic sensor hoses 108, 110. Gauge 106 responds to any differential pressure in motor 102 and is calibrated to display the differential pressure in units of torque (ft·lbs). Such calibration reflects the fact that the torsional force delivered by output shaft 104 is proportional to the differential pressure generated by motor 102. The differential pressure of motor 102 is communicated to gauge 106 by sensor hoses 108,110.

Gauge 106 may include optional control valve 112 connected to hoses 108, 110; optional snubbers 114 connected to control valve 112; gauge face 116 connected to snubbers 114 or valve 120; and gauge housing 118 connected to optional mounting straps 120. Additionally, a system of the present disclosure may optionally include equipment boom 122 to support motor 102 and other equipment.

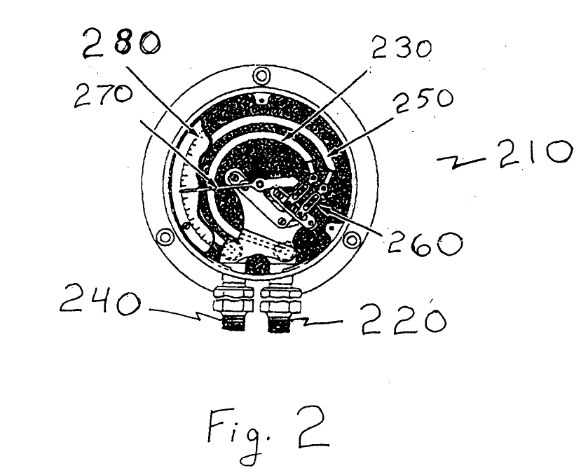

FIG. 2 is a top view cross-section schematic drawing showing the internal mechanisms a typical hydraulic differential pressure gauge. Port 220 is in fluid communication with small tube 230. Port 240 is in fluid communication with large tube 250. An assembly 260 of levers, pins and pivots is connected to tubes 230, 250 and is also connected to pointer 270 calibrated (by methods known in the art) to dial 280 so that a small movement of tubes 230, 250 is amplified to produce a relatively large movement of pointer 270 across dial 280.

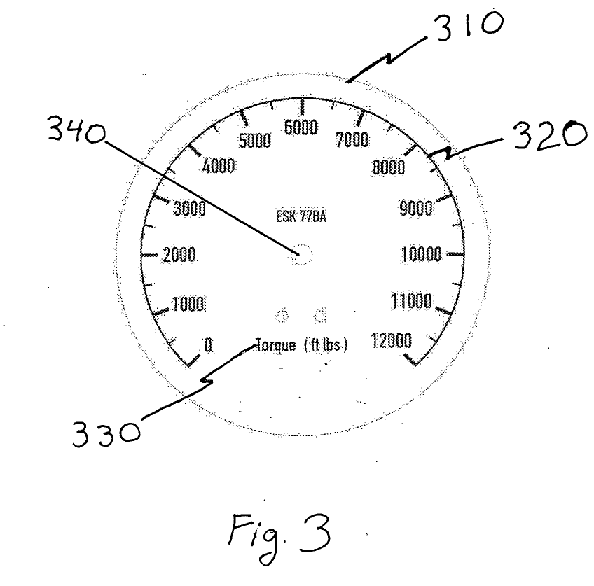

FIG. 3 is a front view schematic drawing of an exemplary specific embodiment of a gauge face of the present disclosure. Face 310 may display measurement markings 320. Measurement markings 320 may be calibrated to a known motor so that the markings correspond to torque (ft.lbs) 330 output proportional to the differential pressure generated by the known motor. Center perforation 340 permits gauge face 310 to be mounted on a gauge housing so that pointer 270 is disposed over face 310.

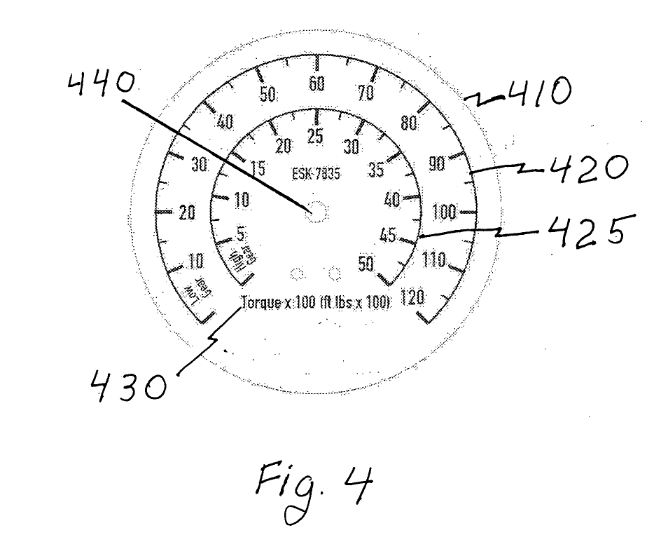

FIG. 4 is a front view schematic drawing of an exemplary specific alternative embodiment of a gauge face of the present disclosure. Gauge face 410 may display measurement markings 420, 425. Measurement markings 420, 425 may be calibrated to one or more known motors, or to a known motor having more than one gear ratio driving an output shaft. In the embodiment of FIG. 3, for example, measurement markings 420 may be calibrated to low gear operation of a known motor and measurement markings 425 may be calibrated to the motor operating at high gear. The markings 420, 425 correspond to torque (ft·lbs) output proportional to the differential pressure generated by the known motor. Torque measurements displayed by face 410 may be scaled 430 to provide markings that are easy to discern. In the embodiment depicted in FIG. 4, for example, the markings display ft·lbs ×100 so that the display is uncluttered by long numbers. Center perforation 440 permits gauge face 410 to be mounted on a gauge housing so that pointer 270 is disposed over face 410.

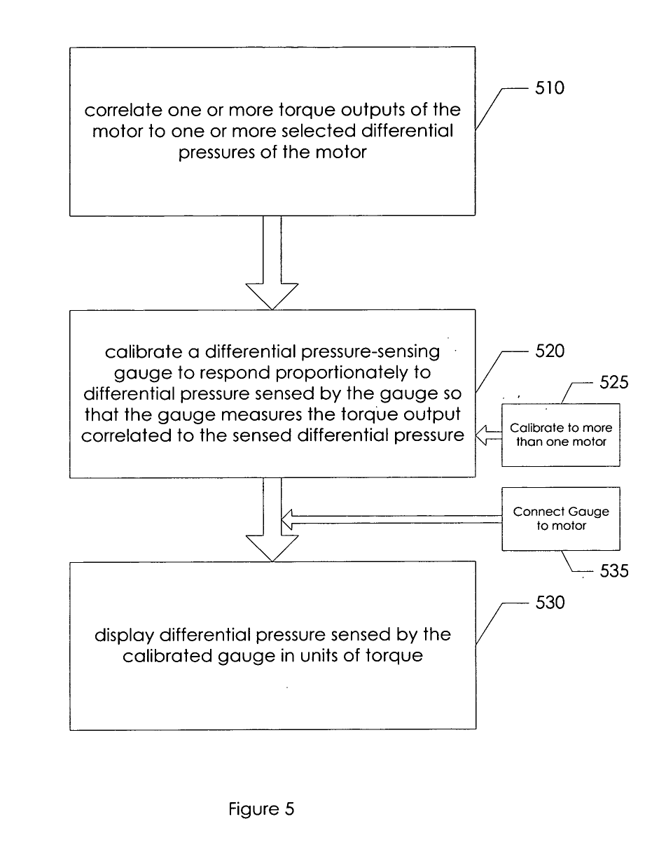

FIG. 5 is a flow chart of a specific exemplary embodiment of a method of the present disclosure. One or more methods of displaying on a gauge the torque output of a motor may include, but not necessarily be limited to correlating 510 one or more torque outputs of the motor to one or more selected differential pressures of the motor; calibrating 520 a differential pressure-sensing gauge to respond proportionately to differential pressure sensed by the gauge so that the gauge measures the torque output correlated to the sensed differential pressure; and displaying 530 differential pressure sensed by the calibrated gauge in units of torque.

One or more of the methods may further include connecting 525 the calibrated gauge to the motor.

One or more of the methods may still further include calibrating 535 one or more gauges to more than one motor so that at least one of the gauges is adapted to measure the torque output of more then one motor.

When installing helical (screw type) earth anchors, the installation torque is directly related to the ultimate axial capacity of the installed screw anchor. Hydraulic motor pressure drop during anchor installation is proportional to anchor installation torque. Anchor installation torque, in turn, is proportional to the ultimate capacity of the installed anchor. Accordingly, the present disclosure measures the hydraulic motor pressure drop, converts the differential pressure measurement to units of torque (foot pounds) and displays the amount of torque measured across the motor.

A useful application of the present gauge is for the installation of screw anchors and screw pilings, for example, used in the electrical utility and general construction industries. When using a hydraulic motor on a gear box, or anchor/auger drive, such as manufactured by Eskridge™, Altec™, Simon-Telelect™, and the like, accurate readings of pressure drop are vital in determining actual torque output. These manufacturers, and others, provide data charts that illustrate that pressure drop is the critical factor when determining the output torque of the digger. The present gauge takes the pressure drop measurement across the hydraulic motor and is calibrated to display the measurement in foot pounds of torque. In the case of screw anchor or screw piling installation, once the installation torque is known, the ultimate axial capacity of the screw anchor or screw piling can be readily calculated using accepted industry standards.

The present disclosure contemplates systems that provide everything needed to get started measuring torque output quickly and easily. A kit embodiment of the present disclosure, for example, features the VersaMount™ mounting bracket that may be temporarily or permanently installed on construction equipment. Equipment mount embodiments offers multiple options, including but not limited to welded studs for bolting clips; clips welded to Equipment; clips bolted to one or more mounting bracket; clips welded to one or more mounting bracket; and mounting bracket secured on equipment with ratchet load binders.

For quick and easy fit-up to a hydraulic motor, a kit embodiment features Adapta-Fit™ custom fittings that easily connect a gauge of the present disclosure to hydraulic motors commonly used in the utility and construction industries. Special fittings allow hoses to be plumbed easily. Fittings with a machined thread allow a third fitting to connect sensor lines to the torque indicator. The gauge's light weight, compact size and adaptability make it compatible with all types of utility and construction equipment.

The disclosure describes a highly portable device that can easily and quickly be installed on, and removed from, any type of construction equipment. Certain embodiments of a gauge of the present disclosure may be mountable on a variety of equipment that uses a positive displacement hydraulic motor to produce a rotational force (torque), and the torque needs to be known or monitored.

Weather-proof embodiments are preferred.

Specific embodiments provide a device having at least one vibration dampening feature.

Advantageously, a device of the present disclosure may be accurate enough to be used as testing equipment.

Direction control valve embodiments may easily monitor torque in either direction without having to switch hoses, if, for instance, the torque-generating system is reversed.

A gauge display face of the present disclosure may display ft-lbs. of torque for individual motor specifications and may also or alternatively display values in PSI (pounds per square inch).

Specific embodiments, such as depicted in FIG. 3, provide inline pressure relief (valve) to relieve hydraulic pressure in the device when a predetermined value is reached. Alternative embodiments do not provide a valve for pressure relief.

Devices of the present disclosure may be easily closed up and ready for shipment from jobsite to jobsite. Such devices may be used on any positive displacement hydraulic motor to indicate the amount of torque output by that motor.

Torque indicator systems of the present disclosure may be plumbed with transducers to provide logging capabilities, and may be plumbed with transducers to provide an electrical signal when a trigger pressure is reached to power a signal light, alarm or other devices to indicate when a predetermined pressure has been reached. Additionally, specific embodiments provide built-in snubbers to protect the sensing unit.

For screw anchor and screw piling installations, a gauge of the present disclosure is a useful tool for onsite Quality Control. The sensing unit of the gauge reads accurately within +/−1%, with certificates of accuracy traceable to NIST standards. Such a gauge may continuously monitor and display readings throughout anchor installation or other uses. When weak soils are encountered, the change is immediately detected, no matter what the depth of the anchor. An alarm may be connected to alert to sudden or significant reading changes.

Shear pin-type torque indicators—in addition to being very time consuming to use—are unable to provide continuous monitoring and readout, which can result in the failure to meet installation specifications.

Some embodiments of a device of the present disclosure may use no cylinders or other moving internal parts, which means that cylinder maintenance requirements may be reduced. Inaccuracies inherent in cylinder type systems, i.e., internal wear and tear creating internally leaking seals affecting accuracy or the effects of hysteresis on the readings are also eliminated.

Torque indicators that are part of a drill string rotate with the anchor. The physical arrangement makes it difficult to take a continuous reading. The readout value has to be “guesstimated” as the gauge rotates past the observer. A gauge of the present disclosure, in contrast, displays through a gauge face that can be conveniently placed, so monitoring readout is easy and accurate. A simple yet rugged and dependable design is another advantage of the present disclosure.

The ability to monitor the torque of a system is important for the safety of field personnel and to protect digger motors, tooling and anchors from damage due to excessive torque. All motors, tooling and anchors have maximum torsional capacities. Damage may occur when these capacities are exceeded. Personnel can be and have been seriously injured when torque exceeds the capacity of a component.

The present disclosure gives continuous readouts displaying the torque throughout the anchor installation. This allows the installation crew to ensure that all work is carried out within the safe limits of the equipment and materials. This may help avoid accidents and reduce downtime and costly repairs to capital equipment. Thus, in addition to measuring hydraulic motor pressure drop and predicting ultimate axial capacity of screw anchors, another advantage of the present disclosure is safety.

Specific embodiments contemplate a rugged and dependable design able to cope with weather extremes, for instance, to eliminate environmental concerns such as extreme high and low temperatures, and the effects of precipitation.

Alternative embodiments contemplate digital readouts and yet other embodiments further contemplate a microprocessor for programmability so that the gauge may be calibrated for a wide range of motors. Programmable embodiments further contemplate computer-readable media containing instructions executed by the microprocessor to calibrate the gauge readout for a plurality of motors, where each motor has a different conversion factor to convert differential pressure units to torque units.

By accurately measuring installation torque, only the material and construction time necessary to meet job specifications may be expended. Easy installation on construction equipment saves time in the field. Conservation of material and time that results in significant cost savings is another advantage of the present disclosure.

A device of the present disclosure may be designed to work with virtually all hydraulically powered installation equipment commonly found in the electrical utility and general construction industries. While described herein with the specific application of a tool for monitoring installation torque of screw anchors, the present disclosure is suitable for any application that requires knowledge of the running torque being applied by a positive displacement hydraulic motor. Examples of other applications include:

Utility Industry—Line trucks, boom trucks for anchor installation or auguring

Drilling/Foundation Rigs;

Heavy construction equipment equipped with a hydraulic motor;

All common hydraulic diggers, i.e., Eskridge™, Simon-Telelect™, and Altec™;

Military equipment;

Hydraulic motor manufacturers who need accurate verification of output torque as a quality control measure; and

Equipment manufacturers who manufacture products or systems utilizing hydraulic motors where knowledge or verification of the output torque of the hydraulic motors is required as a quality control measure.

The present description makes reference to several exemplary embodiments. It is understood, however, that the words that have been used are words of description and illustration, rather than words of limitation. Changes may be made within the purview of the appended claims, as presently stated and as amended, without departing from the scope and spirit of the disclosure in all its aspects. Although the disclosure has been described with reference to particular means, materials and embodiments, the disclosure is not intended to be limited to the particulars disclosed; rather, the disclosure extends to all functionally equivalent technologies, structures, methods and uses such as are within the scope of the disclosure.

We claim:

1. A gauge comprising:
one or more ports connectable to a differential pressure motor having one or more torsional output members;
a differential pressure sensor assembly in communication with one or more of the ports; and
a torque indicator responsive to the sensor assembly.

2. The gauge of claim 1, wherein the torque indicator comprises an analogue face plate having markings in units of torque.

3. The gauge of claim 2, further comprising a pointer connected to the sensor assembly and disposed to point to markings on the face plate.

4. The gauge of claim 1, wherein at least one of the ports comprises a hydraulic port.

5. The gauge of claim 1, further comprising one or more mounting members to facilitate mounting the gauge on a suitable support.

6. The gauge of claim 1, further comprising a housing to house the ports, sensor assembly and torque indicator.

7. A method of displaying on a gauge the torque output of a motor; the method comprising:
correlating one or more torque outputs of the motor to one or more selected differential pressures of the motor;
calibrating a differential pressure-sensing gauge to respond proportionately to differential pressure sensed by the gauge so that the gauge measures the torque output correlated to the sensed differential pressure; and
displaying differential pressure sensed by the calibrated gauge in units of torque.

8. The method of claim 7, further comprising connecting the calibrated gauge to the motor.

9. The method of claim 7, further comprising calibrating one or more gauges to more than one motor so that at least one of the gauges is adapted to measure the torque output of more then one motor.

10. A kit comprising:
one or more gauges that display units of torque;
one or more connectors to connect at least one of the gauges to at least one motor; and
one or more mounting members for mounting at least one of the gauges to a suitable support.
